(19) United States
(12) Patent Application Publication
(10) Pub. No.: US 2008/0167033 A1
(43) Pub. Date: Jul. 10, 2008

(54) Method and Apparatus for Cost-Based Network Selection

(75) Inventor: Michel Beckers, Eindhoven (NL)

Correspondence Address: COATS & BENNETT, PLLC, 1400 Crescent Green, Suite 300, Cary, NC, 27518, US

(73) Assignee: TELEFONAKTIEBOLAGET LM ERICSSON (PUBL), Stockholm (SE)

(21) Appl. No.: 11/619,859

(22) Filed: Jan. 4, 2007

(51) Int. Cl. H04Q 7/20

(52) U.S. Cl. 455/432.3

(57) ABSTRACT

A method and apparatus taught herein supports cost-based network selection for wireless communication devices while roaming, such as for cellular phones or other mobile stations. In at least one embodiment, processing circuit(s) in the wireless communication device are configured to maintain a service usage profile and one or more service cost profiles. The service usage profile reflects tracked usage patterns, and may reflect user-indicated service usage preferences, while the service cost profiles reflect service cost information for a number of communication networks offering roaming services to the wireless communication device. In a roaming circumstance, the circuit(s) predicts service usage costs for one or more currently available communication networks based on the service usage profile and the corresponding service cost profiles. The circuit(s) may be configured to automatically select the cheapest network, or display a ranked listing and allow the user to select a network.

### BACKGROUND

1. Technical Field

The present invention generally relates to wireless communication devices, and particularly relates to supporting cost-based selection of a supporting communication network when roaming.

2. Background

Many network operators offer wireless communication services on a subscription or pay-as-you-go basis. As a general proposition, users understand the costs associated with the communication services used by them, at least when they access such services through their “home” networks. That is, subscription and pay-as-you-go plans advertise rates and charges assessed by a given service provider when users access communication services directly through network facilities owned or operated by that service provider.

However, most network operators extend their effective coverage areas through roaming agreements entered into with other service providers. Indeed, with some types of wireless communication devices, such as GSM-based cellular phones, a given user may have access to comparable communication services almost anywhere in the world, although the particular communication networks and the affiliated service providers change from country-to-country, or even from region-to-region.

Commonly, users incur extra charges when roaming, particularly when roaming abroad. Problematically, however, cost information is not always readily or conveniently available for roaming networks. More importantly, however, even where roaming network cost information is available to a user of a wireless communication device, it may be difficult to identify which one of the currently available communication networks will provide the lowest actual cost to the user.

For example, one network may offer relatively low cost voice services, but may have relatively higher data services, or may charge a premium for messaging services. As such, it is difficult for a user to assess the overall costs that will be incurred on one roaming network versus another. As such, users of conventional wireless communication devices are not provided with an intelligent or useful basis for cost-based selection of a supporting communication network while roaming.

### SUMMARY

Roaming situations, such as when traveling abroad, may require the selection of a supporting communication network. Even where comparative service cost information is available, however, it is difficult to recognize which communication network will be the cheapest to use. To that end, a method and apparatus taught herein enable selection of the communication network that is predicted to yield the lowest actual service costs in contemplation of past service usage patterns determined for the wireless communication device.

In one embodiment, a method of supporting cost-based communication network selection for a roaming wireless communication device includes maintaining a service usage profile at the wireless communication device, and maintaining service cost profiles at the wireless communication device for a plurality of communication networks. The method further includes predicting usage costs for one or more currently available communication networks based on the service usage profile and the service cost profiles.

In at least one such embodiment, the wireless communication device is configured to select the currently available communication network corresponding to the lowest predicted cost. In another embodiment, the wireless communication device is configured to display information based on the predicted costs that allows a user of the wireless communication device to select a currently available communication network. For example, the wireless communication device includes a processing circuit configured to display a listing of available networks, ranked according to predicted usage costs. Note, too, that the wireless communication device may include in its display networks not currently available, such as to provide a more complete context for comparing predicted usage costs, but may use display indicia to indicate which networks are available or not available.

In another embodiment, a wireless communication device includes one or more processing circuits configured to support cost-based communication network selection during roaming by the wireless communication device. The processing circuits are configured to maintain a service usage profile at the wireless communication device, maintain service cost profiles at the wireless communication device for a plurality of communication networks, and predict usage costs for one or more currently available communication networks based on the service usage profile and the service cost profiles. In at least one such embodiment, the wireless communication device includes a digital signal processor, a microprocessor, an application specific integrated circuit (ASIC), a field programmable gate array (FPGA), or other digital logic circuit that is configured to perform these functions. For example, the wireless communication device includes a microprocessor-based circuit and associated memory storing computer program instructions which embody a method of cost-based network selection according to the teachings herein.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of one embodiment of a wireless communication device configured for cost-based network selection, shown in context with a number of wireless communication networks available for supporting roaming operations of the wireless communication device.

FIG. 2 is a logic flow diagram of one embodiment of processing logic implementing cost-based network selection.

FIG. 3 is a block diagram of one embodiment of a network selection circuit that may be implemented in hardware and/or software in a wireless communication device, for supporting cost-based network selection.

FIG. 4 is a block diagram of one embodiment of a data structure for a service usage profile used in predicting usage costs for communication services.

FIG. 5 is a block diagram of one or more embodiments of a home communication network configured to provide service cost information for a number of communication networks.

FIG. 6 is a block diagram of one embodiment of a data structure for service cost profiles used in predicting usage costs for communication services.

FIG. 7 is a logic flow diagram of one embodiment of processing logic implementing cost-based network selection.

FIGS. 8 and 9 are logic flow diagrams reflecting different embodiments of selecting a communication network based on predicted usage costs, as determined by the method of FIG. 7, for example.

### DETAILED DESCRIPTION

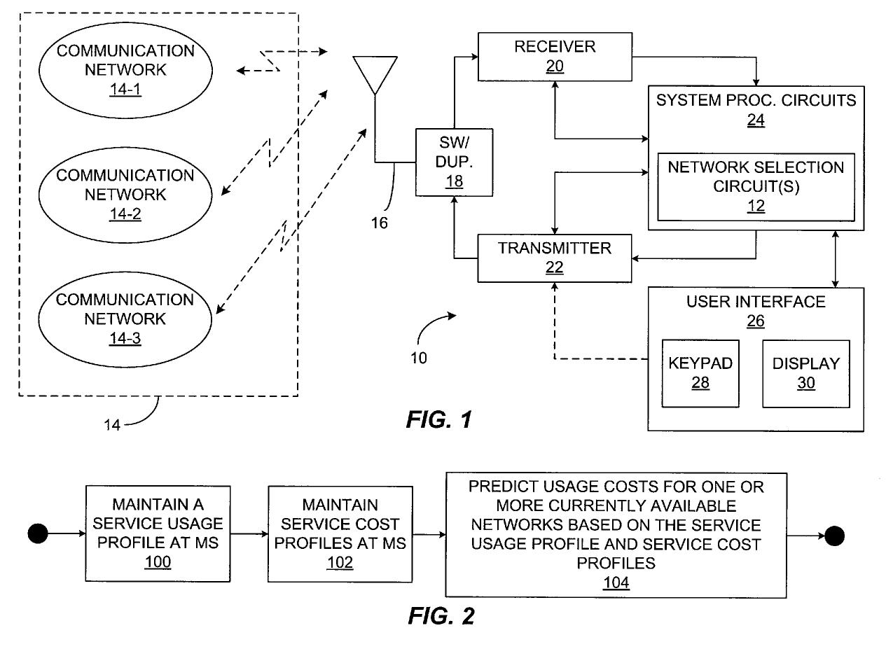

FIG. 1 illustrates a wireless communication device 10 that includes one or more processing circuits referred to herein as a network selection circuit 12. In at least one embodiment, the network selection circuit 12 is configured to identify which one of the currently available communication networks 14 will (or should) offer the lowest usage costs in a roaming scenario, in light of service cost information associated with the networks 14 and stored usage information reflecting usage patterns of the wireless communication device 10.

That is, the wireless communication device 10 is configured to predict the service costs that will be incurred by a user of the wireless communication device 10. The usage cost predictions generally assume that usage of the wireless communication device 10 while being supported by a selected one of the available communication networks 14 will be consistent with the tracked usage patterns of the wireless communication device 10. However, in at least one embodiment, usage preference information, such as whether the user is more interested in email, messaging, web, or other data services, also may be considered by the network selection circuit 12 in the usage cost predictions. In that manner, the network selection circuit 12 can identify the cheapest one of the currently available networks by assuming that the wireless communication device 10 will be used in accordance with tracked usage information and/or based on user preference information bearing on the intended or preferred usage.

A better understanding of the above functionality begins with a more detailed discussion of FIG. 1, which serves as a non-limiting but helpful example. The illustrated wireless communication device 10 comprises one or more antennas 16, a switch or duplexer 18, a communications receiver 20, a communications transmitter 22, and one or more system processing circuits 24, which may comprise digital signal processing circuits, microprocessor-based circuits, and/or other digital processing circuits. Additionally, one or more embodiments of the wireless communication device 10 include a user interface 26, which includes, for example, a keypad 28 for receiving user input, and a display screen 30 for outputting information to the user.

In general the wireless communication device 10 comprises essentially any type of wireless communication module, system, or circuit. In one or more particular embodiments, it comprises a cellular radiotelephone or other mobile station, and thus provides a potentially large number of communication services to its user. For example, depending upon its capabilities, and upon the capabilities of the communication networks supporting it, e.g., cellular communication networks associated with one or more network operators/owners, the wireless communication device 10 may offer a range of voice and data communication services. As non-limiting examples, the wireless communication device 10 offers network-dependent communication services that include voice, multimedia and text messaging, media streaming, web browsing, and email services.

Thus, still referring to FIG. 1, it is assumed that the wireless communication device 10 is activated or otherwise turned on in a “roaming” situation where a number of communication networks 14, e.g., communication networks 14-1, 14-2, and 14-3, are available to support some or all of the types of communication services supported by the wireless communication device 10. With this scenario as an example context, the network selection circuit 12 supports selection of the cheapest one of the available communication networks 12 based on information about past usage stored in the wireless communication device 10, and information about the service costs of the currently available communication networks 14.

FIG. 2 illustrates processing logic for supporting cost-based network selection, which may be implemented in the network selection circuit 12 according to hardware, software, or any combination thereof. For example, in at least one embodiment, the network selection circuit 12 comprises one or more processing circuits that are at least partially configured to carry out the illustrated method in accordance with computer program instructions stored in a memory circuit included in, or accessible to, the network selection circuit 12. In this respect, those skilled in the art should appreciate that, in one or more embodiments, the network selection circuit 12 is a functional circuit logically embodied in a microprocessor-based circuit according to stored computer program instructions.

Further, while FIG. 2 appears to illustrate sequential processing steps, no fixed order or sequence of processing is necessarily implied, and it should be understood that at least some of the processing actions may be performed concurrently, and may represent ongoing or background processing operations. Moreover, it should be understood that the illustrated processing may represent a simplified logic flow in that such processing may be carried out in the larger context of an overall set of processing operations.

In any case, the illustrated processing of FIG. 2 “begins” with maintaining a service usage profile at the wireless communication device 10 (Step 100). Processing further includes maintaining service cost profiles at the wireless communication device 10, for a number of communication networks (Step 102). Processing also includes predicting usage costs for one or more currently available communication networks 14, based on the service usage profile and the service cost profiles (Step 104). In at least one embodiment, the first two steps comprise ongoing or periodic processing operations, such that usage patterns and network cost information are updated periodically or as needed, to reflect changes occurring over time. However, the last step may be performed on an as needed or as appropriate basis, such as when the wireless communication device 10 is first powered on, or is otherwise required initially to register, in a roaming context. An example is in circumstances where a user of the wireless communication device 10 has traveled outside of a home network area, and desires communication support by a foreign (roaming) network operator.

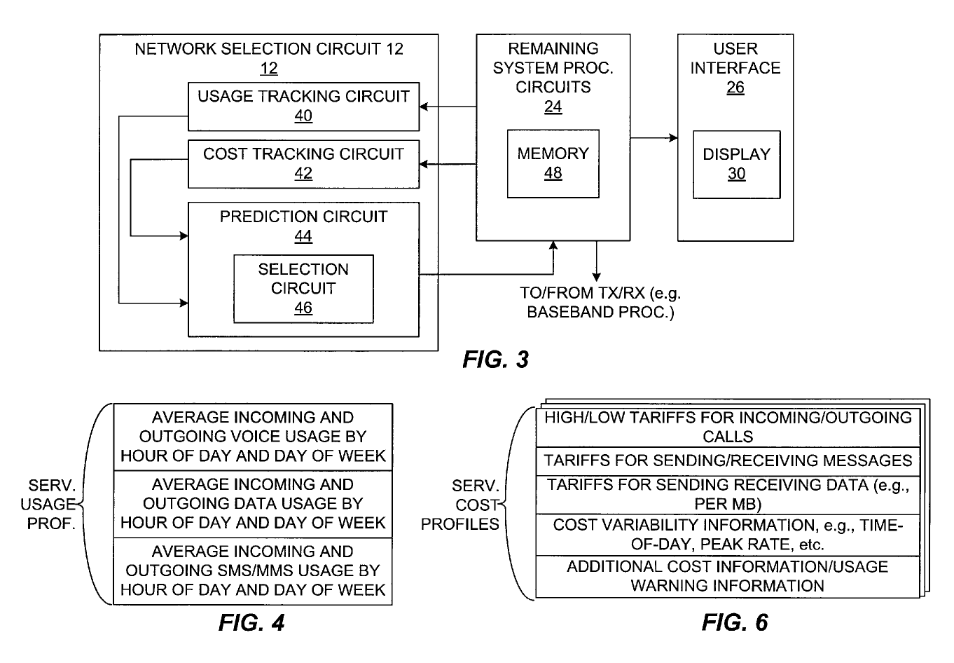

FIG. 3 illustrates one embodiment of the network selection circuit 12 that supports the above cost-based network selection method, and variations of that method. In FIG. 3, the illustrated network selection circuit 12 comprises one or more processing circuits configured as a usage tracking circuit 40, a cost tracking circuit 42, and a prediction circuit 44. Further, the prediction circuit 44 includes or is associated with a selection circuit 46. Additionally, one or more of these circuit elements may include, or may otherwise have access to, one or more memory circuits 48.

Those skilled in the art will appreciate that the illustrated circuit elements may represent a functional circuit arrangement, rather than a literal arrangement of separate physical circuits. That is, the processing circuit(s) comprising the network selection circuit 12 may be implemented in software, microcode, or other program instruction logic.

In any case, the usage tracking circuit 40 is configured to maintain a service usage profile reflecting service usage patterns of the wireless communication device 10. For example, the usage tracking circuit 40 may be configured to maintain the service usage profile by tracking service usage by the wireless communication device 10 for one or more types of communication services. In at least one embodiment, usage tracking circuit 40 tracks service usage by maintaining stored information at the wireless communication device 10 that reflects usage patterns for the wireless communication device 10, for the one or more types of communication services.

In at least one such embodiment, the usage tracking circuit 40 maintains stored information that reflects average usage by the wireless communication device 10 of one or more types of communication services. The average usage information may be maintained for the one or more types of communication services for one or more recurring periods of time. For example, the usage tracking circuit 40 is configured in at least one embodiment to maintain, for each of the one or more types of communication services, average usage information by time of day and day of week. Thus, average usage information may be maintained by the usage tracking circuit 40 for voice services, messaging services, and data services. Further, these service-specific average usages may be separately maintained for incoming and outgoing communications, so that the service usage profile reflects differences in sent data versus received data, differences in originating versus terminating voice calls, etc.

FIG. 4 illustrates an example data structure for the service usage profile, wherein a number of stored values, e.g., records, reflect average service usage information as calculated by the usage tracking circuit 40 for the different types of communication services engaged in by the wireless communication device 10. The service usage profile may be maintained in memory 48, which may comprise one or more memory circuits. In at least one such embodiment, memory 48 includes non-volatile memory (EEPROM, FLASH, etc.), allowing non-volatile storage of service usage profile information. Note, too, that the usage tracking circuit 40 may be configured to communicate with, or receive information from, one or more of the remaining system processing circuits 24, such that it is provided with usage information each time the wireless communication device 10 is used in active communication.

In at least one embodiment, the usage tracking circuit 40 maintains the service usage profile as a three-dimensional store that holds average usage per hour of the day and the day of the week for outgoing calling, incoming calling, SMS and/or MMS send and receive, and data send and receive transfers (e.g., in Mb). As such, the memory needed to maintain the service usage profile is advantageously small, e.g., 24 hours×7 days×8 parameters×2 directions=2,688 bytes. Example contents based on an average value for an hour comprise: calling 00-60 in minutes; called 00-60 in minutes; SMS sent 00-99 quantity; SMS received 00-99 quantity; data sent 00-99 Mb; and data received 00-99 Mb.

Of course, more memory may be allocated. For example, with increasing network speeds SMS and data tracking values might need to go to three or four digits. Additionally, those skilled in the art will appreciate that other parameters may be tracked, and other structural organizations for the service usage profile may be adopted. Indeed, the service usage profile may be tailored to the particular communication services supported and/or used by the wireless communication device 10, and may be tailored to reflect the particular manner in which charges are incurred and/or rates applied to the various communication services.

In any case, the usage tracking circuit 40 generally is configured to update the service usage profile during or after each usage of the wireless communication device 10, such that the service usage profile reflects changing usage patterns. For example, the usage tracking circuit 40 in one embodiment is configured to update the average usage values in the service usage profile using a simple averaging algorithm (stored value*(n−1)+new value)/n. Of course, other, more advanced algorithms may be applied as well, and the particular update algorithm used may change depending upon the usage parameters tracked and the manner in which they are tracked.

Maintaining a service usage profile, however, represents one part of accurate service cost prediction by the wireless communication device 10. That is, tracking service usage enables the wireless communication device 10 to predict, for example, how it will be used at any given hour on any given day, but service cost information is needed to estimate what that usage will cost. More particularly, the ability of the wireless communication device 10 to predict usage cost information for a specific one of the currently available communication networks 14 depends on it having (or receiving) cost information for that particular communication network.

To that end, the cost tracking circuit 42 in one or more embodiments is configured to maintain service cost profiles reflecting the costs (rates/charges/tariffs) for different types of communication services, on each of one or more communication networks. In one embodiment, the method of maintaining service cost profiles at the wireless communication device 10 for a number of communication networks 14 includes, for each communication network in the plurality of communication networks (e.g., for 14-1, 14-2, and 14-3), receiving cost information reflecting usage costs for one or more types of communication services.

In at least one such embodiment, receiving cost information reflecting usage costs for one or more types of communication services comprises periodically receiving updated cost information for one or more of the communication networks 14, such that the wireless communication device 10 maintains current usage cost information for the communication networks.

In one embodiment, the wireless communication device 10 receives cost information from one or more of the currently available networks 14. Such information may be broadcast, or may otherwise be accessed by the wireless communication device 10. Advantageously, however, the wireless communication device 10 in another embodiment already has the relevant cost information based on receiving service cost information for a potentially large number of communication networks from its home communication network.

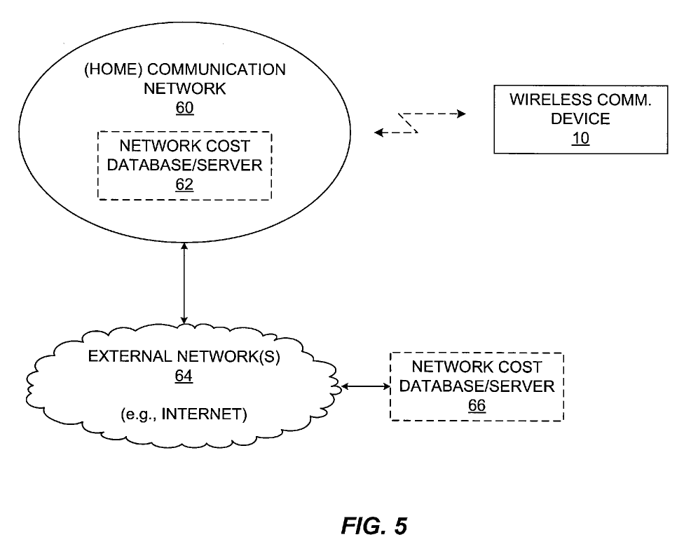

FIG. 5 illustrates one such embodiment, wherein a home communication network 60 for the wireless communication device 10 includes a network cost database/server 62 that stores cost information for a number of communication networks. Additionally, or alternatively, the home communication network 60 communicatively links to one or more external networks 64 (e.g., the Internet), for access to an external network cost database/server 66. Thus, network service cost information may be maintained by network service providers and/or third-party providers, and access to such information may be charged to the user of the wireless communication device 10.

Regardless, such information generally breaks out costs (rates, charges, tariffs, and, optionally, other relevant access/use information) for the different types of communication services supported by each communication network represented in the service cost database. In this sense, the term “communication network” as used in the “service cost” context may represent a given service provider (network owner/operator) for a given geographic region of the world. Thus, the home network 60 provides service cost information for some or all of the various communication networks regionally, nationally, or trans-nationally, on which the wireless communication device 10 can be supported in roaming circumstances.

For example, there are nearly 900 different GSM communication networks/providers worldwide. However, for a given wireless communication device 10, not all of them will be applicable in terms of storing service cost information. In general, service cost information for a given communication network is relevant only if there is a roaming agreement between the device's home operator and the operator of the given communication network. The agreement also may be subject to the type of subscription under which the wireless communication device 10 operates. Because of these constraints, the number of different communication networks 14 for which service cost information is stored is manageable, and the storage capacity needed for storing service cost information may be reasonably limited to less then a thousand network records.

In at least one embodiment, the wireless communication device 10 receives periodic service cost information. For example, the wireless communication device 10 may be configured to download network service cost information updates on a daily or weekly basis. Additionally, or alternatively, the wireless communication device 10 can request such information on an as-needed basis, or in response to user input. In at least one embodiment, the home communication network of the wireless communication device 10 provides service cost information to the wireless communication device 10.

In a specific example, the cost tracking circuit 42 of the wireless communication device 10 updates the service cost profile information stored in the wireless communication device 10 on a daily basis, assuming that the wireless communication device 10 is on for some period of time each day. As noted, updated service cost information may be received from a database owned by the home network operator, thereby providing a competitive argument for choosing that network operator, based on its ability to provide wireless communication devices 10 that can identify the cheapest connection in roaming circumstances. When updating the service cost profiles, only network details relevant to the capabilities of the wireless communication device 10 and/or the user's subscription details are loaded, e.g., GSM/UMTS networks, subscribed communication service types, and home operator limitations. Moreover, the database of network service costs and/or the cost tracking circuit 42 may monitor changed or added records, such that only differential/incremental transfers of network service cost information are needed. Also, in at least one embodiment, the cost tracking circuit 42 or other function within the wireless communication device 10 checks how long it has been since the last update of service cost information, and may use that check as a trigger for retrieving updated information.

FIG. 6 illustrates one embodiment of the service cost profiles, where a profile of service costs for different types of communication services is maintained for each in a number of communication networks. In the illustrated example, service cost information for each communication network represented in the service cost profiles includes: high and low tariffs per minute for being called or calling; tariffs for sending or receiving an SMS; and tariff per Mb for receiving or sending data. Additionally, the information stored for each communication network may include the time frame per day/week for high/low tariffs, and more sophisticated elements like first, second and later usage charges/rates may be included as well. Further, the service cost profiles can include additional information, such as text strings, representing information about non-standard issues relating to service costs, or warnings particular to a given communication network.

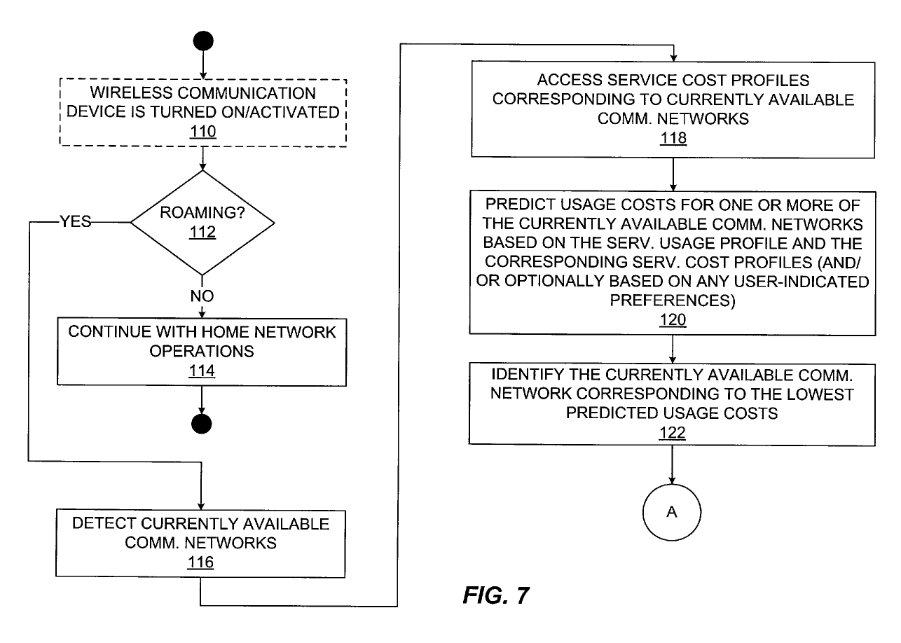

With the service usage profile and the service cost profiles thus available at the wireless communication device 10, FIG. 7 illustrates one embodiment of a method of supporting cost-based network selection for the wireless communication device 10 in roaming circumstances. As with other logic flow diagrams presented herein, the illustrated processing logic does not necessarily limit the method to the particular order or sequence of illustrated processing functions. For example, at least some functions may be performed in a different order, performed concurrently, and/or performed as part of background processing at the wireless communication device 10.

With these points in mind, the method illustrated in FIG. 7 “begins” with the wireless communication device 10 being turned on, or otherwise activated (Step 110). The wireless communication device 10 determines whether it is in a roaming context (Step 112), i.e., in a service area where the device's home network operator does not directly offer communication services. If not, the wireless communication device 10 continues with home network operations (Step 114).

On the other hand, if the wireless communication device 10 determines that it is in a roaming condition, it determines or otherwise identifies the communication networks that are currently available for supporting it (Step 116). Processing continues with the wireless communication device 10 accessing service cost profiles corresponding to the currently available communication networks (Step 118), at least to the extent that the stored service cost profiles include information about the currently available networks.

Processing continues with the prediction circuit 44 (as shown in FIG. 3) predicting service usage costs for one or more of the currently available communication networks (Step 120), to obtain predicted usage costs for each such network. Note, too, that in one or more embodiments, the network selection circuit 12, or other functional circuit within the wireless communication device, is configured to receive and/or store user-entered service preferences that bear on the prediction of usage costs. For example, the user may indicate that he or she is interested in determining which one of the currently available networks is cheapest for data-based services, voice-based services, messaging services, etc. In other words, user-entered data may supplement or substitute for information stored in the service usage profile, such that the usage cost predictions can be tailored to usage scenarios different from, or altered with respect to, those embodied in the tracked usage patterns.

Thus, in at least one embodiment, the one or more processing circuits comprising the network selection circuit 12 are configured to maintain a service usage profile at the wireless communication device by tracking usage patterns by the wireless communication device for one or more types of communication services, such that the service usage profile represents a service usage scenario that provides a basis for predicting usage costs. Further, the network selection circuit 12 is configured to modify the service usage scenario represented by the service usage profile, or to represent one or more additional service usage scenarios in the service usage profile, based on user-input service preferences. With such functionality, the network selection circuit 12 is configured to predict usage costs for one or more currently available communication networks based on the service usage profile and the service cost profiles by predicting service usage costs for each service usage scenario represented in the service usage profile.

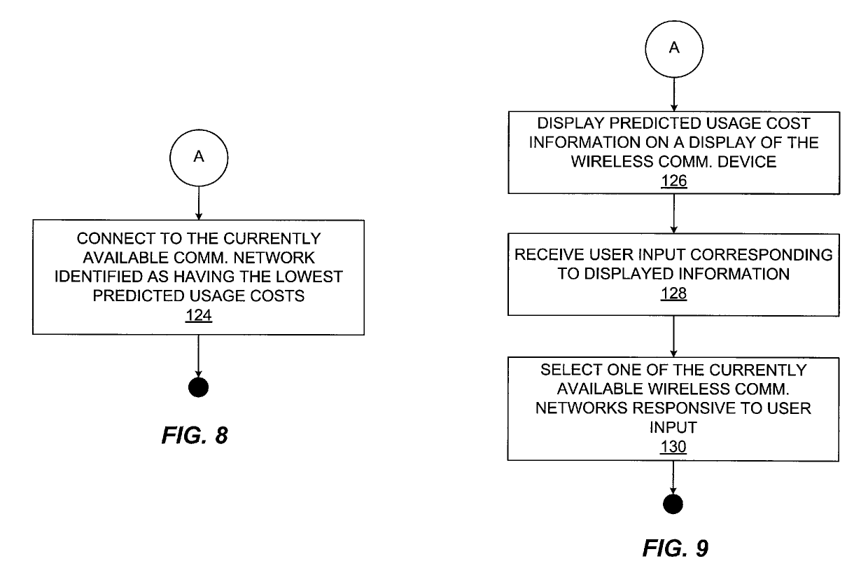

In any case, continued processing from Step 122 for one embodiment is illustrated in FIG. 8, and for another embodiment in FIG. 9. According to the processing logic of FIG. 8, the prediction circuit 44 (automatically) connects to the currently available communication network identified as having the lowest predicted usage costs (Step 124). To that end, the prediction circuit 44 includes or is associated with a selection circuit 46 that cooperates with other functional elements in the wireless communication device 10 to initiate connection with the identified network.

FIG. 9 illustrates another embodiment, wherein processing continues from step 122 with the network selection circuit 12 initiating or otherwise causing the wireless communication device 10 to display (e.g., on its display screen 30) predicted usage cost information (Step 126). For example, it may display a listing that identifies the currently available communication network corresponding to the lowest predicted usage costs. In one embodiment, the network selection circuit 12 causes a listing of some or all the currently available communications networks to be displayed in ranked order, reflecting their respective predicted usage costs. In any case, processing continues with receiving user input indicating a network selection (Step 128), and selection by the network selection circuit 12 or other functional entity within the wireless communication device 10 of the user-selected one of the currently available wireless communication networks.

Additionally, complementing the prediction of usage costs for modified or additional service usage scenarios, at least one embodiment of the network selection circuit 12 is configured to display listings of currently available communication networks for each service usage scenario represented in the service usage profile, ordered in accordance with the predicted usage costs. That is, cost-based lists may be displayed for each service usage scenario represented in the service usage profile, thereby reflecting any user-input service preferences that may have been entered by the user of the wireless communication device 10.

Of course, it should be understood that at least selected ones of the currently unavailable communication networks also may be considered in predicting usage costs, and may be included in the displayed lists, in accordance with their predicted usage costs. Indeed, one or more embodiments taught herein advantageously display information corresponding to unavailable networks, along with, or in addition to the information for the currently available networks. One advantage of doing so is that such displays may provide the user with a better or more familiar basis for comparing predicted usage costs. In at least one such embodiment, the information displays use different indicia to differentiate between currently available and unavailable communication networks, e.g., highlighting, bolding, underlining, or the like.

The same or one or more other embodiments display one or more unavailable communication networks based on alternative or additional considerations. For example, an unavailable communication network may be displayed because it is neighboring with one or more of the currently available communication networks. Displaying such information is particularly helpful where the unavailable but nearby network offers additional services and/or better service quality for one or more types of communication services that may be of particular interest to the user.

Unavailable communication networks also may be displayed on the basis that they should be available, or may become available, given the current location/region of the wireless communication device. In other words, the wireless communication device 10 may be in a location where connectivity to a given communication network is not available, although that network provides service in the general area of the wireless communication device's current location. Unavailable communication networks also may be displayed on the basis of country and/or region codes, which may be stored in the service cost profiles. For example, a given network operator may offer service in high-density urban areas of a given region, but not in rural areas of the same region. Thus, it may be helpful to display the urban communication networks to the user, indicating that they are potentially available for use.

Further, in at least one embodiment, the network selection circuit 12 organizes display information according to different usage scenarios. For example, the display screen 30 may be used to display a ranked list of networks based on predicting usage costs according to tracked usage patterns. However, additionally, or alternatively, the network selection circuit 12 may initiate listings ranked according to various usage scenarios, such as where messaging is weighted more than voice, or where data is weighted more than messaging. In at least one such embodiment, the network selection circuit 12 predicts usage costs based on user-indicated service preferences, and displays corresponding ranked lists reflecting which one of the currently available communication networks is predicted to yield the lowest service costs in view of the indicated service preferences. Regardless of the basis (or bases) for predicting service costs, the method generally includes some mechanism for indicating the (predicted) cheapest one of the currently available communication networks to the user of the wireless communication device 10.

With the above processing in mind, those skilled in the art will appreciated that the network selection circuit 12 generally is configured to predict usage costs for one or more currently available communication networks based on the service usage profile and the service cost profiles. In one embodiment, the prediction circuit 44 is configured to make such predictions by comparing the service usage profile with the service cost profiles for each currently available communication network, to identify which currently available communication network would yield the lowest incurred costs if actual service usage by the wireless communication device 10 comports with service usage profile. However, as noted, at least one embodiment predicts the usage costs based on user-entered data bearing on a service usage preference.

Broadly, then, one or more processing circuits within the wireless communication device 10 are configured to carry out a method of supporting cost-based communication network selection in roaming circumstances. In at least one embodiment the method includes detecting currently available networks in a roaming situation, retrieving service cost information for each such network from stored service cost profiles, and predicting usage costs for each currently available network based on the corresponding service cost profiles and a service usage profile. The method optionally includes selecting the network having the lowest predicted usage costs, or displaying information to the user, thereby allowing the user to make a cost-based network selection. In that latter case, the ranked listing allows the user to select a network having a higher predicted usage cost, based on that user determining that the service cost breakout of the selected network better matches the user's intended service usage.

In at least one embodiment, assuming the wireless communication device 10 is on and roaming, the network selection circuit 12 is configured to initiate regular (e.g., every quarter hour) checks for newly available communication networks. These regular checks enable the wireless communication device 10 to make relevant new usage cost predictions and select a lower cost network if one becomes available, and/or display updated network information to the user. Further, if the currently selected network becomes unavailable, the network selection circuit can select the lowest-cost one of the networks that are available, or can display selection information to the user. In at least one embodiment, the network selection circuit 12 is configured to permit the user to set an option that determines whether the wireless communication device 10 automatically selects the lowest cost one of the currently available networks while roaming, or whether a selection list is displayed to the user for user-driven network selection.

Additionally, in at least one embodiment, the network selection circuit 12 is configured to allow the user to view the service usage profile. Optionally, the network selection circuit 12 is configured to allow the user to modify the service usage profile by adding supplemental or substitute information. Of course, as noted, the network selection circuit 12 also may be configured to receive user-input information indicating service usage preferences bearing on the prediction of usage costs. Such information, which is considered as comprising at least part of the service usage profile, may be received in advance or on-the-fly.

Of course, the foregoing description and the accompanying drawings represent non-limiting examples of the method and apparatus taught herein for cost-based network selection by roaming wireless communication devices. As such, the present invention is not limited by the foregoing description and accompanying drawings. Instead, the present invention is limited only by the following claims and their legal equivalents.

What is claimed is:

1. A method of supporting cost-based communication network selection for a roaming wireless communication device comprising:
maintaining a service usage profile at the wireless communication device;
maintaining service cost profiles at the wireless communication device for a plurality of communication networks; and
predicting usage costs for one or more currently available communication networks based on the service usage profile and the service cost profiles.

2. The method of claim 1, wherein maintaining a service usage profile at the wireless communication device comprises tracking service usage by the wireless communication device for one or more types of communication services.

3. The method of claim 2, wherein tracking service usage by the wireless communication device for one or more types of communication services comprises maintaining stored information at the wireless communication device that reflects usage patterns for the wireless communication device for the one or more types of communication services.

4. The method of claim 1, wherein maintaining a service usage profile at the wireless communication device comprises maintaining stored information at the wireless communication device that reflects average usage by the wireless communication device of one or more types of communication services.

5. The method of claim 4, wherein maintaining stored information at the wireless communication device that reflects average usage by the wireless communication device of one or more types of communication services comprises maintaining average usage information for the one or more types of communication services for one or more recurring periods of time.

6. The method of claim 5, wherein maintaining average usage information for the one or more types of communication services for one or more recurring periods of time comprises, for each of the one or more types of communication services, maintaining average usage information by time of day and day of week.

7. The method of claim 4, wherein maintaining stored information at the wireless communication device that reflects average usage by the wireless communication device of one or more types of communication services comprises, for each of the one or more types of communication services, maintaining average usage information for incoming and outgoing usage.

8. The method of claim 1, wherein maintaining service cost profiles at the wireless communication device for a number of communication networks comprises, for each communication network, receiving cost information reflecting usage costs for one or more types of communication services.

9. The method of claim 8, wherein receiving cost information reflecting usage costs for one or more types of communication services comprises periodically receiving updated cost information for one or more of the communication networks, such that the wireless communication device maintains current usage cost information for the communication networks.

10. The method of claim 1, wherein predicting usage costs for one or more currently available communication networks based on the service usage profile and the service cost profiles comprises comparing the service usage profile with the service cost profiles for each currently available communication network to identify which currently available communication network would yield the lowest incurred costs if actual service usage by the wireless communication device comports with service usage profile.

11. The method of claim 1, wherein predicting usage costs for one or more currently available communication networks based on the service usage profile and the service cost profiles further comprises predicting the usage costs based on user-entered data bearing on a service usage preference.

12. The method of claim 1, further comprising selecting the currently available network having the lowest predicted usage cost.

13. The method of claim 1, further comprising displaying a list of the currently available communication networks to a user of the wireless communication device, ordered according to the predicted usage costs.

14. The method of claim 13, further comprising including one or more currently unavailable communication networks in the list, based on at least one of:
determining that a currently unavailable communication network should be available given a current location of the wireless communication device;
determining that a currently unavailable communication network is neighboring to one or more of the currently available communication networks;
determining that a currently unavailable communication network is neighboring to one or more of the currently available communication networks and offers additional types of communication services or offers better predicted usage costs than the currently available communication networks; or
determining that a currently unavailable communication network has a country or region code relevant to the current location of the wireless communication device.

15. The method of claim 1, further comprising indicating to a user of the wireless communication device which one of the currently available networks has the lowest predicted usage cost.

16. The method of claim 1, wherein maintaining a service usage profile at the wireless communication device comprises tracking usage patterns by the wireless communication device for one or more types of communication services, such that the service usage profile represents a service usage scenario that provides a basis for predicting usage costs.

17. The method of claim 16, further comprising modifying the service usage scenario represented by the service usage profile, or representing one or more additional service usage scenarios in the service usage profile, based on user-input service preferences.

18. The method of claim 17, wherein predicting usage costs for one or more currently available communication networks based on the service usage profile and the service cost profiles comprises predicting service usage costs for each service usage scenario represented in the service usage profile.

19. The method of claim 18, further comprising displaying listings of currently available communication networks for each service usage scenario represented in the service usage profile, ordered in accordance with the predicted usage costs.

20. A wireless communication device comprising one or more processing circuits configured to support cost-based communication network selection during roaming by the wireless communication device based on:
maintaining a service usage profile at the wireless communication device;
maintaining service cost profiles at the wireless communication device for a plurality of communication networks; and
predicting usage costs for one or more currently available communication networks based on the service usage profile and the service cost profiles.

21. The wireless communication device of claim 20, wherein the one or more processing circuits are configured to maintain a service usage profile at the wireless communication device by tracking service usage by the wireless communication device for one or more types of communication services.

22. The wireless communication device of claim 21, wherein the one or more processing circuits are configured to track service usage by the wireless communication device for one or more types of communication services by maintaining stored information at the wireless communication device that reflects usage patterns for the wireless communication device for the one or more types of communication services.

23. The wireless communication device of claim 20, wherein the one or more processing circuits are configured to maintain a service usage profile at the wireless communication device by maintaining stored information at the wireless communication device that reflects average usage by the wireless communication device of one or more types of communication services.

24. The wireless communication device of claim 23, wherein the one or more processing circuits are configured to maintain stored information at the wireless communication device that reflects average usage by the wireless communication device of one or more types of communication services based on maintaining average usage information for the one or more types of communication services for one or more recurring periods of time.

25. The wireless communication device of claim 24, wherein the one or more processing circuits are configured to maintain average usage information for the one or more types of communication services for one or more recurring periods of time by, for each of the one or more types of communication services, maintaining average usage information by time of day and day of week.

26. The wireless communication device of claim 23, wherein the one or more processing circuits are configured to maintain stored information at the wireless communication device that reflects average usage by the wireless communication device of one or more types of communication services by, for each of the one or more types of communication services, maintaining average usage information for incoming and outgoing usage.

27. The wireless communication device of claim 20, wherein the one or more processing circuits are configured to maintain service cost profiles at the wireless communication device for a number of communication networks by, for each communication network, receiving cost information reflecting usage costs for one or more types of communication services.

28. The wireless communication device of claim 27, wherein the one or more processing circuits are configured to receive cost information reflecting usage costs for one or more types of communication services by periodically receiving updated cost information for one or more of the communication networks, such that the wireless communication device maintains current usage cost information for the communication networks.

29. The wireless communication device of claim 20, wherein the one or more processing circuits are configured to predict usage costs for one or more currently available communication networks based on the service usage profile and the service cost profiles by comparing the service usage profile with the service cost profiles for each currently available communication network to identify which currently available communication network would yield the lowest incurred costs if actual service usage by the wireless communication device comports with service usage profile.

30. The wireless communication device of claim 20, wherein the one or more processing circuits are configured to predict usage costs for one or more currently available communication networks based on the service usage profile and the service cost profiles further by predicting the usage costs based on user-entered data bearing on a service usage preference.

31. The wireless communication device of claim 20, wherein the one or more processing circuits are further configured to select the currently available network having the lowest predicted usage cost.

32. The wireless communication device of claim 20, wherein the one or more processing circuits are further configured to display a list of the currently available communication networks to a user of the wireless communication device, ordered according to the predicted usage costs.

33. The wireless communication device of claim 32, wherein the one or more processing circuits are configured to include one or more currently unavailable communication networks in the list, based on at least one of:
determining that a currently unavailable communication network should be available given a current location of the wireless communication device;
determining a currently unavailable communication network is neighboring to one or more of the currently available communication networks;
determining a currently unavailable communication network is nearby or neighboring to one or more of the currently available communication networks and offers additional types of communication services or offers better predicted usage costs than the currently available communication networks; or
determining that a currently unavailable communication network has a country or region code relevant to the current location of the wireless communication device.

34. The wireless communication device of claim 20, wherein the one or more processing circuits are further configured to indicate to a user of the wireless communication device which one of the currently available communication networks has the lowest predicted usage cost.

35. The wireless communication device of claim 20, wherein the one or more processing circuits comprise a usage tracking circuit configured to maintain the service usage profile, a cost tracking circuit configured to maintain the service cost profiles, and a prediction circuit configured to predict the usage costs for the one or more currently available communication networks.

36. The wireless communication device of claim 35, wherein the prediction circuit includes or is associated with a selection circuit that is configured to identify which of the currently available communication networks would yield the lowest incurred costs if actual service usage by the wireless communication device comports with service usage profile.

37. The wireless communication device of claim 36, wherein the selection circuit is configured to perform one of automatically selecting the currently available communication network having the lowest cost, or displaying a ranked list of the currently available communication networks based on the predicted usage costs.

38. The wireless communication device of claim 20, wherein the one or more processing circuits are configured to maintain a service usage profile at the wireless communication device by tracking usage patterns by the wireless communication device for one or more types of communication services, such that the service usage profile represents a service usage scenario that provides a basis for predicting usage costs.

39. The wireless communication device of claim 38, wherein the one or more processing circuits are configured to modify the service usage scenario represented by the service usage profile, or to represent one or more additional service usage scenarios in the service usage profile, based on user-input service preferences.

40. The wireless communication device of claim 39, wherein the one or more processing circuits are configured to predict usage costs for one or more currently available communication networks based on the service usage profile and the service cost profiles by predicting service usage costs for the service usage scenarios represented in the service usage profile.

41. The wireless communication device of claim 40, wherein the one or more processing circuits are configured to display listings of currently available communication networks for each service usage scenario represented in the service usage profile, ordered in accordance with the predicted usage costs.

42. A method of supporting cost-based communication network selection for a roaming wireless communication device comprising:
maintaining a service usage profile at the wireless communication device reflecting service usage patterns for the wireless communication device;
maintaining service cost profiles at the wireless communication device reflecting service costs for one or more communication networks; and
predicting usage costs for currently available communication networks based on the service usage profile and the service cost profiles corresponding to the currently available communication networks.

43. The method of claim 42, wherein maintaining service cost profiles at the wireless communication device reflecting service costs for one or more communication networks includes periodically updating the service cost profiles at the wireless communication device based on receiving updated service cost information for one or more communication networks.

44. The method of claim 42, wherein maintaining a service usage profile at the wireless communication device reflecting service usage patterns for the wireless communication device comprises tracking service usage by the wireless communication device for one or more types of communication services.

45. The method of claim 42, further comprising selecting the currently available communication network having the lowest predicted usage cost for roaming service.

46. The method of claim 42, further comprising displaying to a user of the wireless communication device the currently available communication network having the lowest predicted usage cost for roaming service.
